(19) United States
(12) Patent Application Publication
(10) Pub. No.: US 2010/0297950 A1
(43) Pub. Date: Nov. 25, 2010

(54) CIRCUIT AND METHOD FOR OPERATING A CIRCUIT OF A NODE OF A RADIO NETWORK

(76) Inventors: Tilo FERCHLAND, Dresden (DE); Udo Walter, Dresden (DE); Soeren Schneider, Dresden (DE)

Correspondence Address: Muncy, Geissler, Olds & Lowe, PLLC, 4000 Legato Road, Suite 310, FAIRFAX, VA, 22033, US

(21) Appl. No.: 12/782,868

(22) Filed: May 19, 2010

Related U.S. Application Data
(60) Provisional application No. 61/179,792, filed on May 20, 2009.

(30) Foreign Application Priority Data
May 20, 2009 (DE) DE 102009022108.5

(51) Int. Cl. H04B 7/00

(52) U.S. Cl. 455/69

(57) ABSTRACT

A circuit and a method for operating the circuit of a node of a radio network, wherein a frame, which requires an acknowledgement of the reception, is received by the circuit. A receive power and/or a signal quality of the frame is determined by the circuit. A transmit power for the acknowledgement is adjusted by the circuit based on the determined receive power of the associated frame and/or the determined signal quality of the associated frame, and the acknowledgement is sent with the adjusted transmit power.

This nonprovisional application claims priority to German Patent Application No. DE 10 2009 022 108.5, which was filed in Germany on May 20, 2009, and to U.S. Provisional Application No. 61/179,792, which was filed on May 20, 2009, and which are both herein incorporated by reference.

### BACKGROUND OF THE INVENTION

1. Field of the Invention

The present invention relates to a circuit and a method for operating a circuit of a node of a radio network.

2. Description of the Background Art

Radio networks for different fields of application are known from various industry standards (WLAN, Bluetooth, ZigBee). For example, in the industry standard IEEE 802.15.4, data are transmitted by means of defined frames. A plurality of defined frames requires an acknowledgement (ACK) by a radio network node receiving the frame. The transmit power for sending the acknowledgement can be adjustable, for example. The transmit power of the acknowledgement can be controlled by higher protocol layers, for example.

### SUMMARY OF THE INVENTION

It is therefore an object of the present invention to improve a circuit of a node of a radio network as much as possible. Accordingly, a circuit of a radio network node is provided. A node is formed in this case for communication with other nodes of the radio network over a wireless connection.

The circuit of the node has a receiving circuit for receiving a frame, which requires an acknowledgement of the reception. By means of the acknowledgement, the node confirms the reception of the frame to the node that had previously sent the frame.

The circuit has a transmission circuit for sending the acknowledgement. The acknowledgement is thereby assigned precisely to the previously received frame. The circuit of the node in this case is preferably set up to send the acknowledgement back to the sender of the frame within a time interval defined in the radio network after the reception of the frame.

The circuit has a control circuit for adjusting a transmit power of the acknowledgement. To adjust the transmit power, an output of the control circuit is connected to a control input of the transmission circuit.

The receiving circuit can be formed to output a receive power of the frame and/or a signal quality of the frame. To output the receive power and/or the signal quality, the receiving circuit has an output, which is connected to an input of the control circuit. To output the receive power, the receiving circuit is formed, for example, to perform a quantization of an analog signal correlated to the received field strength. The value of the receive power can also be called an RSSI value (RSSI, Received Signal Strength Indication). The signal quality can be determined, for example, by a correlator of the circuit. The value of the signal quality can also be called an LQI value (LQI, Link Quality Indication).

The control circuit can be set up to adjust the transmit power of the acknowledgement based on the receive power of the associated frame and/or the signal quality of the associated frame. The control circuit is set up to adjust the transmit power after the frame is received and before the acknowledgement is sent. Preferably, the adjustment of the transmit power is hardware-implemented. Preferably, the control circuit has a separate logic for adjusting the transmit power, particularly a state machine, which does not need any resources of a software-controlled arithmetic unit of the circuit.

The object of the invention is furthermore to provide as improved a method as possible for operating a circuit of a node of a radio network. Accordingly, a method for operating a circuit of a node of a radio network is provided. The operation of the circuit thereby comprises the communication with another node of the radio network via wireless links.

In the method, a frame sent by another node is received by the circuit. The frame according to the definition of the radio network requires an acknowledgement of the reception.

A receive power and/or a signal quality of the received frame is determined by the circuit. The determination of the receive power and/or the signal quality occurs in this regard preferably during or after the frame is received but before the acknowledgement is sent.

In the method, a transmit power for the acknowledgement is adjusted by the circuit based on the determined receive power of the associated frame and/or the determined signal quality of the associated frame. The transmit power in this regard is preferably adjusted only based on the single immediately previously received frame, so that earlier received frames are not considered.

The acknowledgement is sent afterwards with the adjusted transmit power. The acknowledgement can be received thereupon by the node that had previously sent the associated frame.

The invention furthermore has as its object to provide an improved use. Accordingly, a use of a determined receive power and/or signal quality to adjust a transmit power of an acknowledgement is provided.

The receive power and/or the signal quality are determined by a frame that a circuit of a node of a radio network receives. According to a definition of the radio network, the acknowledgement of the reception of the frame is to be sent back to the sender of the frame.

The embodiments described hereinafter relate to the circuit, as well as to the use and to the operating method. The functional features of the circuit in this regard emerge from the process steps. Process steps can be derived from the circuit functions.

The receiver of a frame intended for the receiver acknowledges the reception to the sender with the acknowledgement (ACKnowledgement), which can also be called a confirmation. This interaction is a direct link only between these two participants in the radio network. The quality of the channel connection can be deduced from the receive power of the received frame and/or the signal quality of the received frame. With a high signal quality and/or high receive power, the transmit power of the acknowledgement can be reduced. As a result, the power consumption is reduced, provided the determination of the transmit power does not require the starting/initializing/activation of an arithmetic unit, such as, for example, a microcontroller, whose power consumption could greatly lower or totally nullify the power saving produced by the reduction of the transmit power.

According to an embodiment, for the adjustment the transmit power is reduced from a maximum transmit power by a power reduction. As a result, the current uptake by the transmission circuit for sending the acknowledgement is reduced.

The power reduction is determined from a power difference between the receive power of the associated frame and a minimum necessary receive power. Alternatively or in combination, the power reduction can also be determined from the signal quality of the associated received frame. For example, it is possible to compare the signal quality with a threshold and to activate the power reduction of the transmit power only when the threshold is exceeded by the signal quality. If, in contrast, the signal quality is not sufficient, the power reduction is deactivated to enable reliable reception of the acknowledgement under poor transmission channel conditions as well.

According to an embodiment, to adjust the transmit power, a transmit power value, associated with the receive power and/or signal quality, is read out of a table. Preferably, several ranges for the receive power are provided in the table, whereby each range is assigned a transmit power. Preferably, the transmit power values stored in the table represent a stepwise function of the transmit power of the acknowledgement depending on the receive power of the frame. Alternatively, it is possible to compute an associated value (ST_{TX}) of the transmit power (P_{TXACK}) from the receive power (RSSI, P_{RXF}) and/or signal quality (LQI) by an algorithm.

A function, effected by the table, of the transmit power of the acknowledgement depending on the receive power of the frame or the algorithm is programmed particularly by means of higher protocol layers. Preferably, an upper limit and/or lower limit of the adjustable transmit power are programmed particularly by means of higher protocol layers. In another advantageous embodiment, the table is formed multidimensional, so that particularly a functional, for example, stepwise dependence on the signal quality is included.

According to an embodiment, it is provided that the control circuit has a table in a preferably programmable memory with assignments of transmit powers to receive powers of the frame. Preferably, the receive power and/or the signal quality can be applied as a digital value at an input of the table. The table, preferably at its output, outputs a control value for the transmit power of the acknowledgement for the digital value. Preferably, in this regard, the table is set up in such a way that with an increasing receive power of the frame the acknowledgement's transmit power declines particularly stepwise.

The control circuit can be set up to determine a transmit power for the acknowledgement and to compare the determined transmit power with a predefined transmit power by means of a comparator. The predefined transmit power is preferably predefined by programming of a register value. For example, a maximum transmit power for an acknowledgement during the startup of the radio network can be established by means of the predefined transmit power. It is also possible to react to disturbances of other connections of the same radio network, caused by the sending of the acknowledgement, by means of the predefined transmit power.

In an embodiment, the control circuit can be set up to adjust the predefined transmit power for the acknowledgement, when the determined transmit power exceeds the predefined transmit power.

In an embodiment, the control circuit can be set up to activate and deactivate the adjustment of the transmit power based on the receive power and/or the signal quality by means of an enable signal. Preferably, the control circuit has an enable input for activation and deactivation.

The previously described embodiment are especially advantageous both individually and in combination. In this regard, all refinement variants can be combined with one another. Some possible combinations are explained in the description of the exemplary embodiments shown in the figures. These possible combinations of the refinement variants, depicted therein, are not definitive, however.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows a schematic flow diagram;

FIG. 1b shows a schematic representation of two nodes of a radio network;

FIG. 2 shows a schematic diagram;

FIG. 3 shows a schematic block circuit diagram of a node;

FIG. 4a shows a schematic diagram; and

FIG. 4b shows a schematic diagram.

### DETAILED DESCRIPTION

FIG. 1a shows a schematic flow diagram. In this regard, the process for a constellation according to FIG. 1b with two nodes A and B of a radio network is shown. Node A sends a frame F[ACK] which causes an acknowledgement ACK by node B. The acknowledgement ACK can also be called a confirmation. Node A and node B are spaced apart by the distance s from one another. The situation for node A is shown in the process of FIG. 1a. The receiver (node) A of the frame F[ACK] intended for it confirms the reception to the sender (node) B with a confirmation (acknowledgement) ACK. This interaction is a direct link only between these two participants—nodes A and B. The quality of the channel connection can be deduced from the energy values of the received frame and/or signal quality. With very good transmission conditions, the transmit power of the acknowledgement ACK can be significantly reduced. With less favorable transmission conditions, the reduction is smaller. An upper and/or a lower limit for the reduction are established by higher protocol layers.

In FIG. 1a, in the first process step 1, node A is ready for receiving. In the following second step 2, a frame F[ACK], which requires an acknowledgement ACK, is received by node A. In the following third step 3, a receive power P_{RXF} is determined from the reception of the frame F[ACK]. In the following fourth step 4, from the receive power P_{RXF}, associated with the frame F[ACK], a transmit power P_{TXACK} for sending the acknowledgement ACK associated with the frame F[ACK] is determined. For example, to determine the transmit power P_{TXACK}, it can be computed from the receive power P_{RXF}using an algorithm. Preferably, the transmit power P_{TXACK} is determined by assignment by reading a value for the transmit power P_{TXACK} out of a table (LUT, Look Up Table) for a receive power P_{RXF}. In step 5, the acknowledgement ACK is sent with the adjusted transmit power P_{TXACK}.

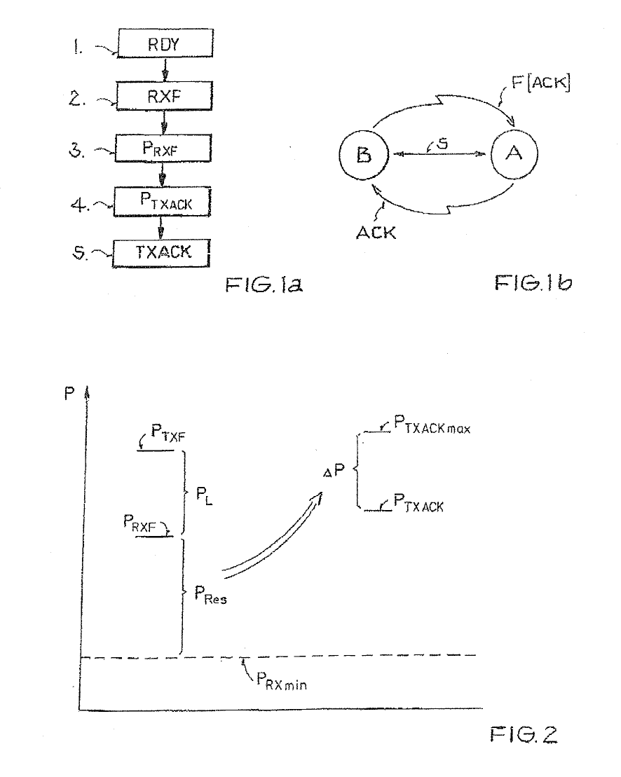

A schematic diagram with several drawn powers P is shown in FIG. 2. Node B sends the frame F[ACK] with the transmit power P_{TXF}. Particularly owing to attenuation in the transmission channel, an attenuation of the transmitted signal and thereby the power loss P_{L} occur. Node A receives the frame F[ACK] with the receive power P_{RXF} associated with the frame F[ACK]. The power difference P_{Res} between the receive power P_{RXF} of the frame F[ACK] and a minimum necessary receive power P_{RXmin} can also be called a power reserve P_{Res}.

Based on said power difference P_{Res}, control of the transmit power P_{TXACK} of an acknowledgement ACK associated with the frame F[ACK] occurs. For control, the transmit power of a maximum transmit power P_{TXACKmax} of the acknowledgement ACK is reduced by a power reduction ΔP to a lower value P_{TXACK}.

The power reduction ΔP in this regard is determined by node A from the currently determined receive power P_{RXF} of the frame F[ACK]. In so doing, the transmit power P_{TXF} of node B, associated with frame F[ACK], and the power losses P_{L} in the transmission channel are not known for node A. Accordingly, node A adjusts the power reduction ΔP to be the same or preferably smaller than the power reserve P_{Res}.

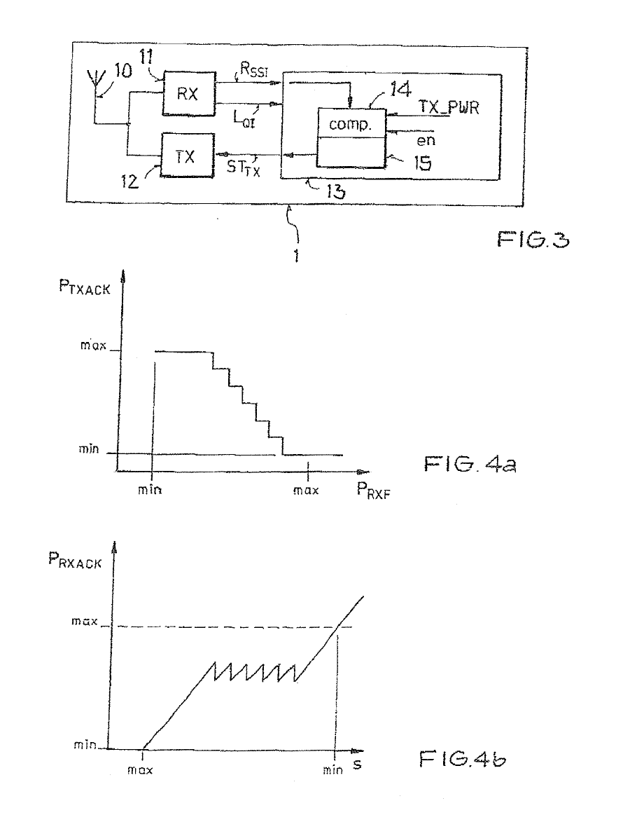

The adjustment of the power reduction occurs preferably by means of a table, which enables an especially power-saving implementation with low computational effort. An exemplary embodiment of an assignment of a transmit power P_{TXACK} to a receive power P_{RXF} with use of a table is shown schematically by means of the diagram in FIG. 4a. At the maximum receive power P_{RXF} of the frame F[ACK], the transmit power P_{TXACK} of the acknowledgement ACK is adjusted to a minimum value. At the minimum receive power P_{RXF} of the frame F[ACK], the transmit power P_{TXACK} of the acknowledgement ACK is adjusted to a maximum value. Stepwise gradations are provided between these two assignments by the table.

FIG. 4b shows the effects of this assignment in a diagram in which the receive power P_{RXACK} of the acknowledgement ACK in node B as a function of the distance s between the two nodes A and B is depicted schematically. The effect of the gradation is evident in the central area. The power consumption of node A can be reduced by controlling the transmit power P_{TXACK} of the acknowledgement ACK. An advantageous effect in this regard is that the reduced current consumption is not detrimentally affected by a complicated computation of the transmit power P_{TXACK}.

A block diagram of a circuit 1 of a radio network node A is shown schematic in FIG. 3. Circuit 1 has an antenna 10, which is connected to a receiver circuit 11 and to a transmission circuit 12. Alternatively, an antenna can be provided separately for transmitting and for receiving. Transmission circuit 12 in this regard has at least one analog amplifier (not shown), whose amplification can be adjusted to adjust a transmit power P_{TXACK}. The transmit power P_{TXACK} in this regard is controlled by means of a control signal St_{TX}.

Receiver circuit 11 is formed and configured to output an RSSI value for the receive power P_{RXACK} and a quality value LQI for the signal quality of a received frame F[ACK]. An evaluation circuit 13 is preferably a digital circuit, which evaluates the RSSI value for the receive power P_{RXACK} and the quality value LQI and, based on the RSSI value for the receive power P_{RXACK} and/or of the quality value LQI for the signal quality, controls transmission circuit 12 by means of the control signal St_{TX}.

By means of a comparison function 14 of evaluation circuit 13, the control value St_{TX} for the appropriate transmit power P_{TXACK} of an acknowledgement ACK associated with frame F[ACK] is computed from the RSSI value for the receive power P_{RXACK} of the received frame F[ACK]. If the computed transmit power P_{TXACK} is greater than a predefined, preferably programmed, power value TX_PWR, transmission circuit 12 for the predefined power value is controlled. If, in contrast, the computed transmit power P_{TXACK} is smaller than the predefined (programmed) power value TX_PWR, transmission circuit 12 is controlled according to the computed transmit power P_{TXACK}. The control based on the computed transmit power P_{TXACK} can be turned on and off by means of the enable signal en. In the turned-off state, the transmit power P_{TXACK} for the acknowledgement ACK is always adjusted according to the predefined power value TX_PWR.

A table 15 is implemented in evaluation circuit 13. A control value St_{TX} for controlling transmission circuit 12 is stored in table 15 for each transmit power P_{TXACK}. Circuit 1 according to FIG. 3 in this regard has the advantage that the control of the transmit power of the acknowledgement occurs exclusively via specifically adapted hardware. The use of software in an arithmetic unit, for example, a microcontroller, is not necessary, so that the power consumption can be reduced further. In addition, the surprising effect is achieved that the disturbance of other nodes in the radio network is reduced, because the receive power of the acknowledgement not intended for them is lower.

The invention is not limited to the shown embodiment variants of FIGS. 1a through 4b. For example, it is possible in addition to regulate the transmit power P_{TXF} of node B. In so doing, methods for computing the transmit power P_{TXF} in higher protocol layers can be used for regulating the transmit power P_{TXF} of node B. The invention is used preferably for a radio network according to an industry standard, particularly IEEE 802.15.4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a circuit of a node of a radio network, the method comprising:
receiving by the circuit a frame that requires an acknowledgement of the reception;
determining a receive power and/or a signal quality of the frame by the circuit;
adjusting a transmit power for the acknowledgement by the circuit based on the determined receive power of the associated frame;
determining a power reduction from a power difference between the receive power of the associated frame and a minimum necessary receive power;
reducing the transmit power for the adjustment from a maximum transmit power by a power reduction; and
transmitting the acknowledgement with the adjusted transmit power.

2. The method according to claim 1, further comprising:
determining a signal quality of the frame by the circuit;
adjusting the transmit power for the acknowledgement by the circuit based on the determined signal quality of the associated frame; and/or
determining the power reduction based on the determined signal quality of the associated frame.

3. The method according to claim 1, wherein, to adjust the transmit power, a value of the transmit power associated with the receive power and/or signal quality is obtained from a table.

4. The method according to claim 1, wherein a value associated with the transmit power is computed from the receive power and/or signal quality by an algorithm.

5. A circuit of a node of a radio network, the circuit comprising:
a receiving circuit configured to receive a frame that requires an acknowledgement of the reception;
a transmission circuit configured to transmit the acknowledgement; and
a control circuit configured to adjust a transmit power of the acknowledgement,
wherein the receiving circuit is configured to output a receive power of the frame;
wherein the control circuit is configured to adjust the transmit power of the acknowledgement based on the receive power of the associated frame,
wherein the control circuit is configured to determine a power reduction from a power difference between the receive power of the associated frame and a minimum necessary receive power, and
wherein, to adjust the transmit power of the acknowledgement, the control circuit is configured to reduce the transmit power from a maximum transmit power by the power reduction.

6. The circuit according to claim 5, wherein the control circuit has a table with assignments of transmit powers for the acknowledgement and of received powers of the frame.

7. The circuit according to claim 5, wherein the control circuit is configured to determine a transmit power for the acknowledgement and is configured to compare the determined transmit power with a predefined transmit power via a comparator.

8. The circuit according to claim 7, wherein the control circuit is configured to adjust the predefined transmit power for the acknowledgement when the determined transmit power exceeds the predefined transmit power.

9. The circuit according to claim 5, wherein the control circuit is configured to activate and deactivate the adjustment of the transmit power of the acknowledgement based on the received power of the associated frame and/or the signal quality of the associated frame via an enable signal.

10. The circuit according to claim 5, wherein the receiving circuit is configured to output a signal quality of the frame, and wherein the control circuit is configured to adjust the transmit power for the acknowledgement based on the determined signal quality of the associated frame, and/or to determine the power reduction based on the determined signal quality of the associated frame.

11. A circuit of a node of a radio network, the circuit comprising:
a receiving circuit configured to receive a frame that requires an acknowledgement of the reception;
a transmission circuit configured to transmit the acknowledgement; and
a control circuit configured to adjust a transmit power of the acknowledgement,
wherein the receiving circuit is configured to output a signal quality of the frame, and
wherein the control circuit is configured to adjust the transmit power of the acknowledgement based on the signal quality of the associated frame.

12. The circuit according to claim 10, wherein the control circuit is configured to compare the signal quality with a threshold, and wherein the control circuit is configured to reduce the transmit power of the acknowledgement when the signal quality exceeds the threshold.

13. The circuit according to claim 10, wherein the control circuit has a table with assignments of transmit powers for the acknowledgement and with values of the signal quality of the frame.
